(19) United States
(12) Patent Application Publication
(10) Pub. No.: US 2022/0112133 A1
(43) Pub. Date: Apr. 14, 2022

(54) SUPERHARD CONSTRUCTIONS & METHODS OF MAKING SAME

(71) Applicant: ELEMENT SIX (UK) LIMITED, DIDCOT (GB)

(72) Inventor: VALENTINE KANYANTA, DIDCOT (GB)

(73) Assignee: ELEMENT SIX (UK) LIMITED, DIDCOT (GB)

(21) Appl. No.: 17/346,804

(22) Filed: Jun. 14, 2021

Related U.S. Application Data
(63) Continuation of application No. 16/474,182, filed on Jun. 27, 2019, now abandoned.

(30) Foreign Application Priority Data
Dec. 31, 2016 (GB) 1622474.3

(51) Int. Cl. C04B 35/5831; E21B 10/567; C04B 35/52

(52) U.S. Cl. CPC C04B 35/5831; E21B 10/5676; C04B 35/52; C04B 2235/78; C04B 2235/386; C04B 2235/76; C04B 2235/427

(57) ABSTRACT

A super hard polycrystalline construction is disclosed as comprising a body of super hard material bonded to a substrate. The body of super hard material comprises an outer peripheral region formed of interbonded grains of super hard material extending peripherally around one or more inner regions, the outer peripheral region having a radial thickness proportional to the square of the ratio of the fracture toughness of the material forming said outer peripheral region to the transverse rupture strength of the material forming said outer peripheral region (K_{IC}/TRS)² where TRS is the transverse rupture strength and K_{IC} is the fracture toughness.

### CROSS-REFERENCE TO RELATED APPLICATIONS

This application is a continuation of U.S. patent application Ser. No. 16/474,182, filed on Jun. 27, 2019, which is a U.S. national phase of International Patent Application No. PCT/EP2017/084378, filed on Dec. 22, 2017, which claims the benefit of United Kingdom Patent Application No. 1622474.3, filed on Dec. 31, 2016, each of which is incorporated herein by reference in its entirety.

### FIELD

This disclosure relates to super hard constructions and methods of making such constructions, particularly but not exclusively to constructions comprising polycrystalline diamond (PCD) structures attached to a substrate, and tools comprising the same, particularly but not exclusively for use in rock degradation or drilling, or for boring into the earth.

### BACKGROUND

Polycrystalline super hard materials, such as polycrystalline diamond (PCD) and polycrystalline cubic boron nitride (PCBN) may be used in a wide variety of tools for cutting, machining, drilling or degrading hard or abrasive materials such as rock, metal, ceramics, composites and wood-containing materials. In particular, tool inserts in the form of cutting elements comprising PCD material are widely used in drill bits for boring into the earth to extract oil or gas. The working life of super hard tool inserts may be limited by fracture of the super hard material, including by spalling and chipping, or by wear of the tool insert.

Cutting elements such as those for use in rock drill bits or other cutting tools typically have a body in the form of a substrate which has an interface end/surface and a super hard material which forms a cutting layer bonded to the interface surface of the substrate by, for example, a sintering process. The substrate is generally formed of a tungsten carbide-cobalt alloy, sometimes referred to as cemented tungsten carbide and the super hard material layer is typically polycrystalline diamond (PCD), polycrystalline cubic boron nitride (PCBN) or a thermally stable product TSP material such as thermally stable polycrystalline diamond.

Polycrystalline diamond (PCD) is an example of a super hard material (also called a superabrasive material or ultra hard material) comprising a mass of substantially inter-grown diamond grains, forming a skeletal mass defining interstices between the diamond grains. PCD material typically comprises at least about 80 volume % of diamond and is conventionally made by subjecting an aggregated mass of diamond grains to an ultra-high pressure of greater than about 5 GPa, and temperature of at least about 1,200° C., for example. A material wholly or partly filling the interstices may be referred to as filler or binder material.

PCD is typically formed in the presence of a sintering aid such as cobalt, which promotes the inter-growth of diamond grains. Suitable sintering aids for PCD are also commonly referred to as a solvent-catalyst material for diamond, owing to their function of dissolving, to some extent, the diamond and catalysing its re-precipitation. A solvent-catalyst for diamond is understood be a material that is capable of promoting the growth of diamond or the direct diamond-to-diamond inter-growth between diamond grains at a pressure and temperature condition at which diamond is thermodynamically stable. Consequently the interstices within the sintered PCD product may be wholly or partially filled with residual solvent-catalyst material. Most typically, PCD is often formed on a cobalt-cemented tungsten carbide substrate, which provides a source of cobalt solvent-catalyst for the PCD.

Ever increasing drives for improved productivity in the earth boring field place ever increasing demands on the materials used for cutting rock. Specifically, PCD materials with improved abrasion and impact resistance are required to achieve faster cut rates and longer tool life.

Cutting elements for use in rock drilling and other operations require high abrasion resistance and impact resistance. One of the factors limiting the success of the polycrystalline diamond (PCD) abrasive cutters is the generation of heat due to friction between the PCD and the work material. This heat causes the thermal degradation of the diamond layer. The thermal degradation increases the wear rate of the cutter through increased cracking and spalling of the PCD layer as well as back conversion of the diamond to graphite causing increased abrasive wear.

Methods used to improve the abrasion resistance of a PCD composite often result in a decrease in impact resistance of the composite. There is therefore a need for a polycrystalline super hard composite construction that has improved impact resistance whilst also having good abrasion resistance and a method of forming such a construction.

### SUMMARY

Viewed from a first aspect there is provided a super hard polycrystalline construction comprising:

a body of super hard material bonded to a substrate; wherein the body of super hard material comprises:

an outer peripheral region formed of interbonded grains of super hard material extending peripherally around one or more inner regions, the outer peripheral region having a radial thickness proportional to the square of the ratio of the fracture toughness of the material forming said outer peripheral region to the transverse rupture strength of the material forming said outer peripheral region (K_{IC}/TRS)² where TRS is the transverse rapture strength and K_{IC} is the fracture toughness.

Viewed from a further aspect there is provided a tool comprising the superhard polycrystalline construction defined above, the tool being for cutting, milling, grinding, drilling, earth boring, rock drilling or other abrasive applications.

The tool may comprise, for example, a drill bit for earth boring or rock drilling, a rotary fixed-cutter bit for use in the oil and gas drilling industry, or a rolling cone drill bit, a hole opening tool, an expandable tool, a reamer or other earth boring tools.

Viewed from another aspect there is provided a drill bit or a cutter or a component therefor comprising the superhard polycrystalline construction defined above.

### BRIEF DESCRIPTION OF THE DRAWINGS

Various versions will now be described by way of example and with reference to the accompanying drawings in which:

FIG. 1 is a perspective view of an example of a PCD cutter element or construction for a drill bit for boring into the earth;

FIG. 2 is a schematic cross-section of a conventional portion of a PCD micro-structure with interstices between the inter-bonded diamond grains filled with a non-diamond phase material;

FIGS. 3 to 13 are schematic plan views of various examples of super hard constructions;

FIG. 14 is a schematic diagram showing the steps in the method of preparing an example cutter element; and

FIG. 15 is a plot showing the results of a vertical borer test comparing three example cutters with a conventional PCD cutter element.

The same references refer to the same general features in all the drawings.

### DESCRIPTION

As used herein, a “super hard material” is a material having a Vickers hardness of at least about 28 GPa. Diamond and cubic boron nitride (cBN) material are examples of super hard materials.

As used herein, a “super hard construction” means a construction comprising a body of polycrystalline super hard material. In such a construction, a substrate may be attached thereto.

As used herein, polycrystalline diamond (PCD) is a type of polycrystalline super hard (PCS) material comprising a mass of diamond grains, a substantial portion of which are directly inter-bonded (intergrown) with each other and in which the content of diamond is at least about 80 volume percent of the material. In one example of PCD material, directly after sintering, interstices between the diamond grains may be at least partly filled with a binder material comprising a catalyst for diamond. As used herein, “interstices” or “interstitial regions” are regions between the diamond grains of PCD material.

A “catalyst material” for a super hard material is capable of promoting the growth or sintering of the super hard material.

The term “substrate” as used herein means any substrate over which the super hard material layer is formed. For example, a “substrate” as used herein may be a transition layer formed over another substrate.

As used herein, the term “integrally formed” means regions or parts are produced contiguous with each other and are not separated by a different kind of material.

FIG. 1 is a schematic view of an example of a conventional PCD super hard construction such as a cutting element 1 which includes a substrate 3 with a layer of super hard material 2 formed on the substrate 3. The substrate 3 may be formed of a hard material such as cemented tungsten carbide. The super hard material 2 may be, for example, high density polycrystalline diamond (PCD) comprising at least 80 vol % of interbonded (intergrown) diamond grains. The cutting element 1 may be mounted into a bit body such as a drag bit body (not shown) and may be suitable, for example, for use as a cutter insert for a drill bit for boring into the earth.

The exposed top surface of the super hard material opposite the substrate forms the cutting face 4, also known as the working surface, which is the surface which, along with its edge 6, performs the cutting in use.

At one end of the substrate 3 is an interface surface 8. As shown in FIG. 1, the substrate 3 is generally cylindrical and has a peripheral surface 10 and a peripheral top edge 12.

The working surface or “rake face” 4 of the polycrystalline composite construction 1 is the surface or surfaces over which the chips of material being cut flow when the cutter is used to cut material from a body, the rake face 4 directing the flow of newly formed chips. This face 4 is commonly also referred to as the top face or working surface of the cutting element as the working surface 4 is the surface which, along with its edge 6, is intended to perform the cutting of a body in use. It is understood that the term “cutting edge”, as used herein, refers to the actual cutting edge, defined functionally as above, at any particular stage or at more than one stage of the cutter wear progression up to failure of the cutter, including but not limited to the cutter in a substantially unworn or unused state.

As used herein, “chips” are the pieces of a body removed from the work surface of the body being cut by the polycrystalline composite construction 1 in use.

As used herein, a “wear scar” is a surface of a cutter formed in use by the removal of a volume of cutter material due to wear of the cutter. A flank face may comprise a wear scar. As a cutter wears in use, material may progressively be removed from proximate the cutting edge, thereby continually redefining the position and shape of the cutting edge, rake face and flank as the wear scar forms.

The substrate 3 is typically formed of a hard material such as a cemented carbide material, for example, cemented tungsten carbide.

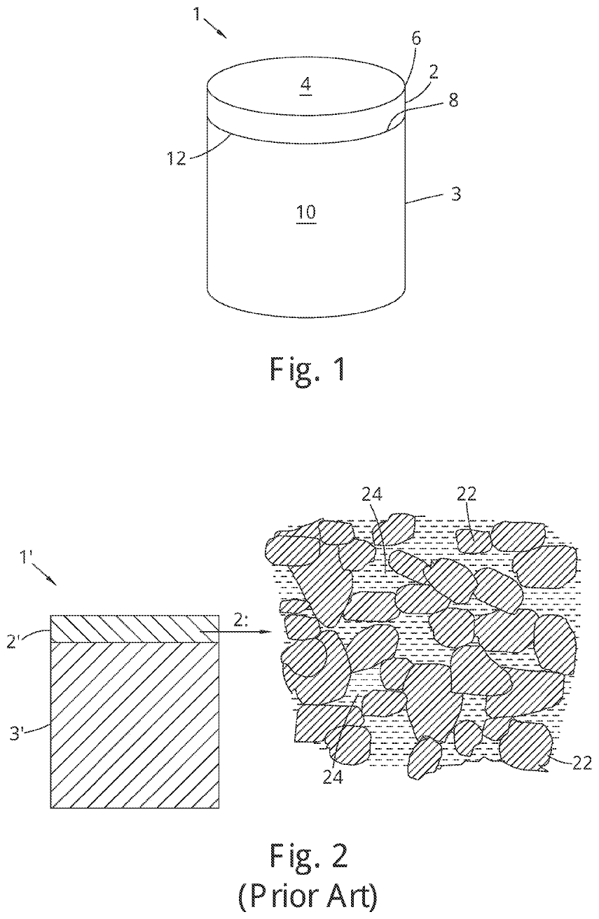

As shown in FIG. 2, during formation of a conventional polycrystalline composite construction 1, the interstices 24 between the inter-bonded grains 22 of super hard material such as diamond grains in the case of PCD, may be at least partly filled with a non-super hard phase material. This non-super hard phase material, also known as a filler material may comprise residual catalyst/binder material, for example cobalt.

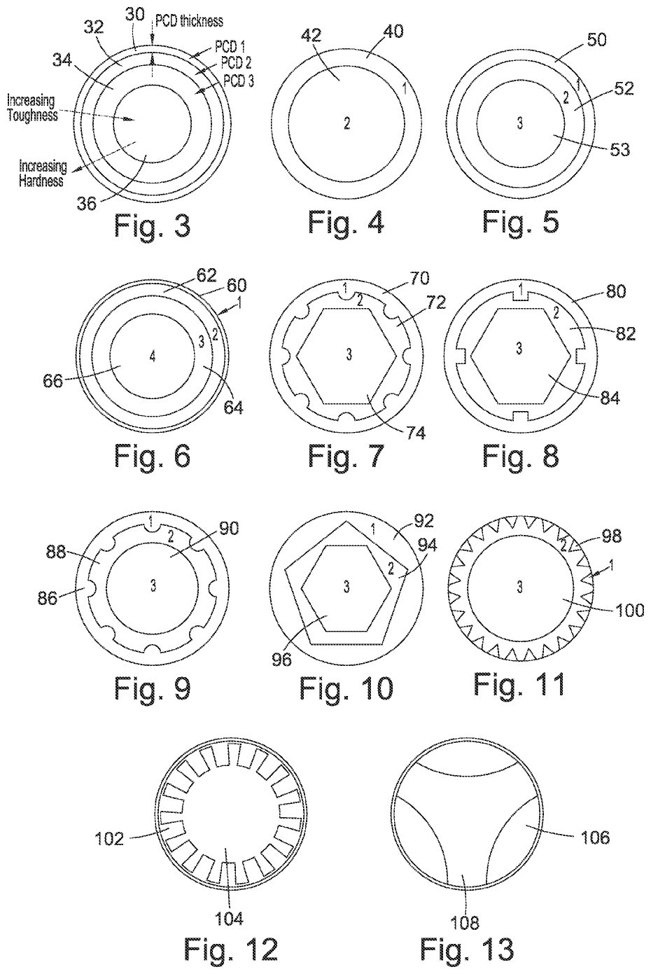

In a first example, as shown in FIG. 3, the body of super hard material 2 for use as part of a cutter element of the type shown in FIG. 1, comprises a first outer region 30 in the form of an outer ring. A first inner ring 32 is located concentrically within the outer diameter of the first outer region 30 and a second ring 34 is located concentrically within bore of first inner ring 32. Within the bore of the second ring 34 is located a cylindrical core region 36.

An example of a further super hard construction is shown in FIG. 4 and differs from that shown in FIG. 3 in that the body of super hard material 2 comprises a single outer ring 40 extending around a concentrically located core portion 42.

A further example of a super hard construction is shown in FIG. 5 and differs from that shown in FIG. 3 in that the body of super hard material 2 comprises an outer ring 50, an inner ring 52 located concentrically therein and extending around an inner core region 53.

FIG. 6 is an example similar to that shown in FIG. 3 with the exception that the outer ring 60 surrounding the inner rings 62, 64 and core region 66 is thinner than that shown in FIG. 3.

FIG. 7 is a schematic plan view of a still further example in which the peripheral outer surface of a first inner ring 72 is grooved such that the interface with the inner surface defining the walls of the bore through the outer ring 70 is uneven. Additionally, the inner core region 74 has a substantially hexagonal cross-sectional shape.

The further example of FIG. 8 differs from that shown in FIG. 7 in that the shape of the grooves is not concave as in FIG. 7 and there are fewer grooves in the outer peripheral surface of the inner ring 82 along the interface with the outer ring 80, the core region 84 having a substantially hexagonal cross-sectional shape.

The example of FIG. 9 differs from that shown in FIG. 7 in that the inner core region 90 is substantially cylindrical in cross-sectional shape, the grooves in the outer peripheral surface of the inner ring 88 being substantially concave along the interface with the outer ring 86.

The example of FIG. 10 differs from that shown in FIG. 8 in that the inner ring 94 has a pentagonal cross-sectional shape and the outer peripheral surface adjacent the outer ring 92 does not have grooves therein. The inner core 96 is hexagonal in cross-section.

As shown in the plan views of FIGS. 11, 12 and 13, the inner regions of examples may have more complex cross-sectional shapes. For example, in FIG. 11 the inner ring may have a corrugated outer peripheral surface, the inner core region 100 being substantially cylindrical in cross section. In the example of FIG. 12 the outer peripheral surface of the core region 104 may have a number of protrusions protruding into the inner surface of the inner ring 102. In the example of FIG. 13 the inner core region 108 may be shaped such that it divides the inner ring 106 into a number of segments, the outer ring extending around the inner ring 106. The advantage of such a construction may be that the construction may be rotatable after use such that a different cutting edge may be presented to the surface to be cut and also the segments may act to confine damage to a limited area of the construction during use.

In one or more of the examples, such as those shown in any one or more of FIGS. 3 to 13, any one or more of the outer rings 30, 40, 50, 60, 70, 80, 86, 92, and/or any one or more of the inner rings 32, 34,52, 62, 64, 72, 82, 88, 94, 102, 106 and/or the core regions 36, 42, 53, 66, 74, 84, 90, 96, 100, 104, 108 may comprise super hard polycrystalline material formed of diamond grains and/or cBN material. The composition of the regions may differ in composition from the other of said regions such as in elemental composition or average grain size and may be selected to suit the desired application of the construction. For example, in the construction of FIG. 3, the outer ring, first and second inner rings may be formed of PCD material having progressively increasing toughness from the outer ring to the inner core, and increasing hardness from the inner core region to the outer ring.

In some examples, the core region may be formed of superhard material or a hard material such as a cemented carbide eg WC.

The regions in the examples are arranged co-axially with, in some examples, the more abrasive resistant super hard region having, for example the finest average size of diamond particles, adjacent to the cutting surface or forming the periphery of the super hard body. The average radial thickness of the outer ring being chosen to be proportional to the square of the ratio of fracture toughness to transverse rapture strength (K_{IC}/TRS)², and/or proportional to the average size of the super abrasive particles.

In highly impact dominated end applications, the radial thickness of the outer ring is chosen to be less than 100 times (K_{IC}/TRS)² or even less than 50 times (K_{IC}/TRS)².

In some examples, the radial thickness of the outer ring is not more than 200 times (K_{IC}/TRS)².

In some examples, (K_{IC}/TRS)² is equivalent to the average diamond particle size and hence the particle size may be used in determining the desired radial thickness of the outer ring.

In some examples, the average diamond grain size for the outer ring is less than 20 microns.

In some examples, the core region furthest from the cutter periphery or cutting surface may be designed to have the coarsest average size abrasive particles. The average particle size or (K_{IC}/TRS)² of this region may, for example be not less than 25 microns.

As shown, the super hard body may comprise multiple regions in between the outer ring and the core region. These regions may be of varying radial thickness and may be used for (i) modifying the residual stresses in the cutter, (ii) to provide a gradual gradient of the average particle size between the outer ring and the core region, and (iii) to provide a gradual change in abrasion resistance and impact resistance between the outer ring and the core region.

It is believed that catastrophic failure or spalling may be mitigated by limiting the radial or ring thickness of the outer ring region by a multiple of (K_{IC}/TRS)² according to the amplitude of loads experienced during application, i.e. 200 times, 100 times, or 50 times.

The regions of super hard material shown in FIGS. 3 to 10, prior to final processing and directly after sintering, may for example have a micro-structure with interstices between the inter-bonded grains of super hard material filled with a non-super hard phase material such as that shown in the representation of conventional PCD in FIG. 2. However, in the end product, in the case of the super hard grains being diamond, all or a portion of the interstitial spaces between inter-bonded diamond grains may be substantially free of accessible residual solvent catalyst which may be achieved by subjecting the construction to a leaching treatment to remove such residual catalyst binder, such as an acid leaching treatment.

The super hard material of the various examples used to form the layer or region of super hard material, may be, for example, polycrystalline diamond (PCD) and/or polycrystalline cubic boron nitride (PCBN) and/or lonsdalite and the super hard particles or grains may be of natural and/or synthetic origin.

The substrate of the examples, may be formed of a hard material such as a cemented carbide material and may include, for example, cemented tungsten carbide, cemented tantalum carbide, cemented titanium carbide, cemented molybdenum carbide or mixtures thereof. The binder metal for such carbides suitable for forming the substrate may be, for example, nickel, cobalt, iron or an alloy containing one or more of these metals and may include additional elements or compounds of other materials such as chromium, or vanadium. This binder may, for example, be present in an amount of 10 to 20 mass %, but this may be as low as 6 mass % or less.

In some examples, the layer or region of super hard material may comprise PCBN. Components comprising PCBN are used principally for machining metals. PCBN material comprises a sintered mass of cubic boron nitride (cBN) grains. The cBN content of PCBN materials may be at least about 40 volume %. When the cBN content in the PCBN is at least about 70 volume % there may be substantial direct contact among the cBN grains. When the cBN content is in the range from about 40 volume % to about 60 volume % of the compact, then the extent of direct contact among the cBN grains is limited. PCBN may be made by subjecting a mass of cBN particles together with a powdered matrix phase, to a temperature and pressure at which the cBN is thermodynamically more stable than the hexagonal form of boron nitride, hBN. PCBN is less wear resistant than PCD which may make it suitable for different applications to that of PCD.

As used herein, a PCD or PCBN grade is a PCD or PCBN material characterised in terms of the volume content and size of diamond grains in the case of PCD or cBN grains in the case of PCBN, the volume content of interstitial regions between the grains, and composition of material that may be present within the interstitial regions. A grade of super hard material may be made by a process including providing an aggregate mass of super hard grains having a size distribution suitable for the grade, optionally introducing catalyst material or additive material into the aggregate mass, and subjecting the aggregated mass in the presence of a source of catalyst material for the super hard material to a pressure and temperature at which the super hard grains are more thermodynamically stable than graphite (in the case of diamond) or hBN (in the case of CBN), and at which the catalyst material is molten. Under these conditions, molten catalyst material may infiltrate from the source into the aggregated mass and is likely to promote direct intergrowth between the diamond grains in a process of sintering, to form a polycrystalline super hard structure. The aggregate mass may comprise loose super hard grains or super hard grains held together by a binder material. In the context of diamond, the diamond grains may be natural or synthesised diamond grains.

In particular, the grains of super hard material may be, for example, diamond grains or particles. In the starting mixture prior to sintering they may be, for example, bimodal, that is, the feed comprises a mixture of a coarse fraction of diamond grains and a fine fraction of diamond grains. In some examples, the coarse fraction may have, for example, an average particle/grain size ranging from about 10 to 60 microns. By “average particle or grain size” it is meant that the individual particles/grains have a range of sizes with the mean particle/grain size representing the “average”. The average particle/grain size of the fine fraction is less than the size of the coarse fraction.

Some examples consist of a wide bi-modal size distribution between the coarse and fine fractions of super hard material, but some examples may include three or even four or more size modes.

Sizing of diamond particles/grains into fine fraction, coarse fraction, or other sizes in between, may be through known processes such as jet-milling of larger diamond grains and the like.

In some examples, the cemented metal carbide substrate may, for example, be conventional in composition and, thus, may include any of the Group IVB, VB, or VIB metals, which are pressed and sintered in the presence of a binder of cobalt, nickel or iron, or alloys thereof. In some examples, the metal carbide is tungsten carbide.

In some examples, the substrate may be pre-formed for example by pressing the green body of grains of hard material such as tungsten carbide into the desired shape, including the interface features at one free end thereof, and sintering the green body to form the substrate element. In an alternative example, the substrate interface features may be machined from a sintered cylindrical body of hard material, to form the desired geometry for the interface features. The substrate may, for example, comprise WC particles bonded with a catalyst material such as cobalt, nickel, or iron, or mixtures thereof.

A green body for the superhard construction, which comprises the pre-formed substrate, and the particles of superhard material such as diamond particles or cubic boron nitride particles, may be placed onto the substrate, to form a pre-sinter assembly which may be encapsulated in a capsule for an ultra-high pressure furnace, as is known in the art. In particular, the superabrasive particles, for example in powder form, or pre-formed rings or core regions are placed inside a metal cup formed, for example, of niobium, tantalum, or titanium. The pre-formed substrate is placed inside the cup and hydrostatically pressed into the superhard powder such that the requisite powder mass is pressed around the interface features of the preformed carbide substrate to form the pre-composite. The pre-composite is then outgassed at about 1050 degrees C. The pre-composite is closed by placing a second cup at the other end and the pre-composite is sealed by cold isostatic pressing or EB welding. The pre-composite is then sintered to form the sintered body.

In some examples, the superhard grains may be diamond grains and the substrate may be cobalt-cemented tungsten carbide. The pre-sinter assembly may comprise an additional source of catalyst material such as a disc or surrounding cup containing catalyst material such as cobalt which may be placed adjacent to and/or around the diamond grains in the pre-composite assembly.

In one example, the method may include loading the capsule comprising a pre-sinter assembly into a press and subjecting the green body to an ultra-high pressure and a temperature at which the superhard material is thermodynamically stable to sinter the superhard grains. In some examples, the green body may comprise diamond grains and the pressure to which the assembly is subjected is at least about 5 GPa and the temperature is at least about 1,300 degrees centigrade. In some examples, the pressure to which the assembly may be subjected is around 5.5-6 GPa, but in some examples it may be around 7.7 GPa or greater. Also, in some examples, the temperature used in the sintering process may be in the range of around 1400 to around 1500 degrees C.

After sintering, the polycrystalline super hard constructions may be ground to size and may include, if desired, a 45° chamfer of approximately 0.4 mm height on the body of polycrystalline super hard material so produced.

Solvent/catalyst for diamond may be introduced into the aggregated mass of diamond grains by various methods, including blending solvent/catalyst material in powder form with the diamond grains, depositing solvent/catalyst material onto surfaces of the diamond grains, or infiltrating solvent/catalyst material into the aggregated mass from a source of the material other than the substrate, either prior to the sintering step or as part of the sintering step. Methods of depositing solvent/catalyst for diamond, such as cobalt, onto surfaces of diamond grains are well known in the art, and include chemical vapour deposition (CVD), physical vapour deposition (PVD), sputter coating, electrochemical methods, electroless coating methods and atomic layer deposition (ALD). It will be appreciated that the advantages and disadvantages of each depend on the nature of the sintering aid material and coating structure to be deposited, and on characteristics of the grain.

In one example, the binder/catalyst such as cobalt may be deposited onto surfaces of the diamond grains by first depositing a pre-cursor material and then converting the precursor material to a material that comprises elemental metallic cobalt. For example, in the first step cobalt carbonate may be deposited on the diamond grain surfaces using the following reaction:

Co(NO₃)₂+Na₂CO₃→CoCO₃+2NaNO₃

The deposition of the carbonate or other precursor for cobalt or other solvent/catalyst for diamond may be achieved by means of a method described in PCT patent publication number WO2006/032982. The cobalt carbonate may then be converted into cobalt and water, for example, by means of pyrolysis reactions such as the following:

CoCO₃→CoO+CO₂

CoO+H₂→Co+H₂O

In another example, cobalt powder or precursor to cobalt, such as cobalt carbonate, may be blended with the diamond grains. Where a precursor to a solvent/catalyst such as cobalt is used, it may be necessary to heat treat the material in order to effect a reaction to produce the solvent/catalyst material in elemental form before sintering the aggregated mass.

In some examples, the cemented carbide substrate may be formed of tungsten carbide particles bonded together by the binder material, the binder material comprising an alloy of Co, Ni and Cr. The tungsten carbide particles may form at least 70 weight percent and at most 95 weight percent of the substrate. The binder material may comprise between about 10 to 50 wt. % Ni, between about 0.1 to 10 wt. % Cr, and the remainder weight percent comprises Co.

To render the layer or region of polycrystalline super hard material more thermally stable, the sintered cutter construction may be subjected to a leaching treatment process to remove accessible residual catalyst binder material from that layer or region therein or thereof, for example a boiling HCl acid leaching treatment.

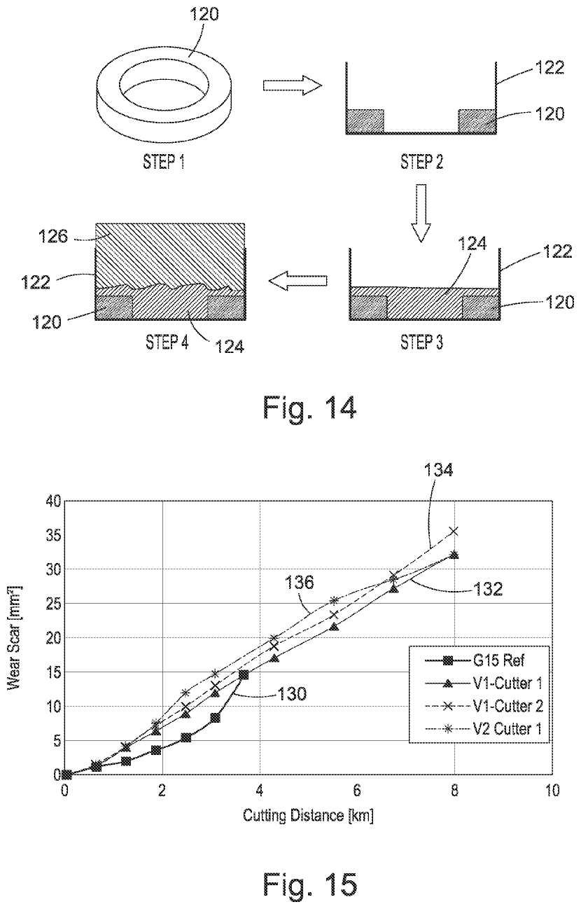

An example is described in more detail below and with reference to FIG. 14 which is provided herein by way of illustration only and is not intended to be limiting.

### EXAMPLE

95 g of diamond grains with a selected average particle size such as around 10 microns, are mixed with 5 g of organic binder. The powders are dried to retain a moisture content of about 5 wt % and sieved to recover desired granulated powders of particular granule sizes. Spray drying and freeze drying may also be used. The prepared powders are pressed in a punch and die fixture at pressures of 5 MPa and above to form a compact green body of the desired shape. The shape of the formed green body may be, for example, a circular or non-circular ring 120, or a circular or non-circular disc. In some examples, rings of different inner diameters may be placed and assembled into each other. The assembled rings and/or discs are then placed in a Nb cup 122. Loose powders of super hard material 124 may be added to fill any cavities in the green bodies. A WC—Co substrate 126 is introduced into the cup and located on top of the green body or bodies and powders to form a pre-sinter assembly. The pre-composite is then subjected to a de-binding step at 680 deg C. for 8 hrs under nitrogen. This is to remove the organic binders used in forming the green body. The de-binding cycle may be changed depending on the type organic binders used.

The pre-composite assembly is then sintered at temperature above 1400 deg C. and pressure above 5 GPa.

The cutter constructions prepared according to the above examples were recovered after sintering and processed.

In some examples, the constructions were treated to remove some or all accessible residual catalyst binder material in the interstitial spaces between the interbonded diamond grains of the sintered construction. This may be achieved by, for example, subjecting the cutter construction to a boiling HCl acid leaching treatment to remove all accessible catalysing material from the PCD structure, but other conventional techniques for leaching may be used.

The cutter constructions of the examples were then subjected to a vertical turret lathe test as was a reference cutter formed of conventional PCD material. The results are shown in FIG. 15.

In this test, the wear flat area was measured as a function of the number of passes of the cutter element boring into the workpiece. The results provide an indication of the total wear scar area plotted against cutting length. As shown in FIG. 15, the example cutter denoted by reference numerals 132, 134 and 136, were able to achieve a longer resistance to spalling indicated by the longer working life than the conventional cutter denoted by reference numeral 130.

Thus it will be seen that the super hard constructions formed according to examples were able to achieve a significant cutting length and small wear scar area showing that the constructions had a long working life.

The super hard constructions of the examples may be finished by, for example, grinding, to provide a super hard element which is substantially cylindrical and having a substantially planar working surface, or a generally domed, pointed, rounded conical or frusto-conical working surface. The super hard element may be suitable for use in, for example, a rotary shear (or drag) bit for boring into the earth, for a percussion drill bit or for a pick for mining or asphalt degradation.

While various versions have been described with reference to a number of examples, those skilled in the art will understand that various changes may be made and equivalents may be substituted for elements thereof and that these examples are not intended to limit the particular versions disclosed.

1. A super hard polycrystalline construction comprising:
a body of super hard material bonded to a substrate; wherein the body of super hard material comprises:
an outer peripheral region formed of interbonded grains of super hard material extending peripherally around one or more inner regions, the outer peripheral region having a radial thickness proportional to the square of the ratio of the fracture toughness of the material forming said outer peripheral region to the transverse rupture strength of the material forming said outer peripheral region (K_{IC}/TRS)² where TRS is the transverse rupture strength and K_{IC} is the fracture toughness.

2. The construction of claim 1, wherein the outer peripheral region has a radial thickness less than 200 times the average grain size of the grains of super hard material in the outer peripheral region.

3. The construction of claim 1, wherein the outer peripheral region has a radial thickness less than 100 times the average grain size of the grains of super hard material in the outer peripheral region.

4. The construction of claim 1, wherein the outer peripheral region has a radial thickness less than 50 times the average grain size of the grains of super hard material in the outer peripheral region.

5. The construction of claim 1, wherein the body of super hard material comprises two or more concentric inner regions located within the outer peripheral region, any one or more of the two or more concentric inner regions having a circular cross section or a noncircular cross-section or a combination thereof.

6. The construction of claim 1, wherein the outer region and any one or more inner regions differ in average grain size of super hard material.

7. (canceled)

8. The construction of claim 1, wherein the outer region comprises grains of super hard material having the smallest average size of the super hard body.

9. The construction of claim 1, wherein the outer region comprises grains of super hard material comprising at least 70% super hard grains by volume or weight.

10. The construction of claim 1, wherein the outer region comprises grains of super hard material having an average grain size of less than 20 microns.

11. The construction of claim 1, wherein the body of super hard material has a core region extending around the central axis of the body, the core region comprising interbonded grains of super hard material having the greatest average grain size in the super hard body.

12. The construction of claim 11, wherein the average grain size of the super hard grains in the core region are greater than 25 microns.

13. The construction of claim 11, wherein the core region comprises at least 70% super hard grains by volume or weight.

14. The construction of claim 11, wherein the core region comprises at least 50% super hard grains by volume or weight.

15. The construction of claim 11, wherein the core region comprises at least 30% super hard grains by volume or weight.

16. The construction of claim 11, wherein the ratio between the average grain size of super hard particles of the core region is at least 1.5 times the average grain size of super hard particles of the outer region.

17. The construction of claim 11, wherein the ratio between the average grain size of super hard particles of the core region is at least 2.5 times the average grain size of super hard particles of the outer region.

18. The construction of claim 1, wherein the outer region and any one or more of the one or more inner regions differ in radial thickness.

19. The construction of claim 1, wherein the radial thickness of the outer region and any one or more of the one or more inner regions increases radially inwards.

20. The construction of claim 1, wherein the super hard grains comprise diamond grains and/or cBN gains.

21. (canceled)

22. The construction according to claim 1, wherein the body has at least one region substantially free of a catalyst material for diamond.

23.-30. (canceled)
